(19) United States
(12) Patent Application Publication
(10) Pub. No.: US 2026/0162672 A1
(43) Pub. Date: Jun. 11, 2026

(54) COMPUTER-IMPLEMENTED METHOD, SYSTEM AND COMPUTER PROGRAM PRODUCT FOR VOICE ACTIVITY DETECTION

(71) Applicant: National Tsing Hua University, Hsinchu (TW)

(72) Inventors: Chi-Chun Lee, Hsinchu (TW); Bo-Cheng Wu, Hsinchu (TW)

(21) Appl. No.: 19/184,520

(22) Filed: Apr. 21, 2025

(30) Foreign Application Priority Data
Dec. 6, 2024 (TW) 113147536

(51) Int. Cl. G10L 25/78; G10L 25/30; G10L 25/93

(52) U.S. Cl. CPC G10L 25/78; G10L 25/93; G10L 25/30

(57) ABSTRACT

The instant disclosure provides a computer-implemented method for voice activity detection (VAD). According to this computer-implemented method, a plurality of first features from an input utterance is extracted by a plurality of feature extractors. Each of the plurality of feature extractors extracts at least one of the plurality of first features, and whether the input utterance corresponds to a target object is determined by a pre-trained classifier and according to the plurality of first features. Each of the plurality of feature extractors is trained by one of a plurality of training sets corresponding to a plurality of different scenarios. In addition, a system and a non-transitory computer-readable medium using this method are also provided.

### CROSS-REFERENCE TO RELATED APPLICATION(S)

The present application claims the benefit of and priority to Taiwan Patent Application Serial No. 113147536, filed on Dec. 6, 2024, entitled “COMPUTER-IMPLEMENTED METHOD, SYSTEM AND COMPUTER PROGRAM PRODUCT FOR VOICE ACTIVITY DETECTION”, the contents of which are hereby incorporated herein fully by reference into the present application for all purposes.

### FIELD

The present disclosure generally relates to a machine learning technology and, more particularly, to a computer-implemented method, system, and computer program product for voice activity detection.

### BACKGROUND

In the existing Voice Activity Detection (VAD) technology, Personal Voice Activity Detection (P-VAD) aims to identify a specific speaker from among multiple speakers. This technology is highly effective in improving the accuracy of voice recognition in a single-speaker environment. However, the technology's performance faces challenges when dealing with scenarios involving multiple simultaneous speakers, where voice signals overlap. Traditional P-VAD systems often fail to effectively separate and identify the voice of individual speakers in such complex auditory environments, thus resulting in a significant decrease in the accuracy of voice detection and recognition.

This issue primarily arises from the fact that traditional personal voice activity detection techniques are designed with a primary focus on the acoustic features of a single speaker, without adequately addressing the interference and overlap of voice signals in multi-speaker scenarios. Additionally, when multiple speakers' voices overlap, the presence of background noise and the acoustic similarity among speakers further exacerbate the difficulty of accurate identification.

Therefore, the limitations of existing technologies in handling the problem of overlapping voices among multiple speakers highlight the need for a more efficient and accurate solution for voice activity detection, particularly one capable of significantly improving the accuracy of voice detection in environments with overlapping multi-speaker scenarios.

### SUMMARY

In view of the foregoing, the present disclosure provides a computer-implemented method, system, and computer program product for voice activity detection, which could effectively distinguish and identify the voice activity of a specific speaker in scenarios involving overlapping voice from multiple speakers.

According to a first aspect of the present disclosure, a computer-implemented method for voice activity detection (VAD) is provided. The computer-implemented method includes: extracting, by a plurality of feature extractors, a plurality of first features from an input utterance, each of the plurality of feature extractors extracting at least one of the plurality of first features; and determining, by a pre-trained classifier and according to the plurality of first features, whether the input utterance corresponds to a target object, where each of the plurality of feature extractors is trained by one of a plurality of training sets corresponding to a plurality of different scenarios.

In an implementation of the first aspect of the present disclosure, where determining, by the pre-trained classifier and according to the plurality of first features, whether the input utterance corresponds to the target object includes: retrieving a plurality of second features corresponding to the target object from a database; calculating a plurality of similarity features based on the plurality of first features and the plurality of second features; and determining, by the pre-trained classifier and according to the plurality of similarity features, whether the input utterance corresponds to the target object, where each of the plurality of second features correspond to one of the plurality of different scenarios.

In another implementation of the first aspect of the present disclosure, the plurality of different scenarios comprises a plurality of numbers of simultaneous speakers.

In another implementation of the first aspect of the present disclosure, where a number of the plurality of second features in each of the plurality of different scenarios is positively correlated with a number of the simultaneous speakers in each of the plurality of different scenarios.

In another implementation of the first aspect of the present disclosure, where each of the plurality of numbers of simultaneous speakers does not exceed five.

In another implementation of the first aspect of the present disclosure, where determining, by the pre-trained classifier and according to the plurality of first features, whether the input utterance corresponds to the target object includes: retrieving a plurality of sound features corresponding to a plurality of users from the database; and determining, based on the plurality of similarity features, the plurality of sound features, and one of the plurality of first features, whether the input utterance corresponds to the target object through the pre-trained classifier.

In another implementation of the first aspect of the present disclosure, where the method further includes: creating the plurality of training sets corresponding to the target object in the plurality of different scenarios; training each of the plurality of feature extractors by one of the plurality of training sets; obtaining, by the plurality of feature extractors which is trained, a plurality of embedding vectors corresponding to the plurality of different scenarios; and storing the plurality of embedding vectors in the database, where the plurality of embedding vectors includes the plurality of second features.

In another implementation of the first aspect of the present disclosure, where the plurality of feature extractors comprises a number of five.

According to a second aspect of the present disclosure, a voice activity detection system is provided. The voice activity detection system includes: a memory storing multiple feature extractors; and a processor coupled to the memory and configured to perform the computer-implemented method according to a first aspect of the present disclosure.

According to a third aspect of the present disclosure, a non-transitory computer-readable medium is provided. The non-transitory computer-readable medium includes: at least one instruction, where when the at least one instruction is executed by a processor of an electronic device, the electronic device is configured to perform the computer-implemented method according to a first aspect of the present disclosure.

### BRIEF DESCRIPTION OF THE DRAWINGS

The present description will be better understood from the following detailed description when read in light of the accompanying drawings, where:

FIG. 1 is a schematic diagram illustrating a voice activity detection method according to an example implementation of the present disclosure.

FIG. 2 is a flowchart illustrating a voice activity detection method according to an example implementation of the present disclosure.

FIG. 3 is a schematic diagram illustrating a voice activity detection method according to an example implementation of the present disclosure.

FIG. 4 is a schematic diagram illustrating a voice activity detection method according to an example implementation of the present disclosure.

FIGS. 5A and 5B are line graphs illustrating an impact of a number of feature extractors on accuracy according to an example implementation of the present disclosure.

FIG. 6 is a block diagram illustrating a computing system according to an example implementation of the present disclosure.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

For convenience, certain terms employed in the specification, examples, and appended claims are collected here. Unless otherwise defined herein, scientific, and technical terminologies employed in the present disclosure shall have the meanings that are commonly understood and used by one of ordinary skill in the art. Also, unless otherwise required by context, it will be understood that singular terms shall include plural forms of the same, and plural terms shall include the singular. Specifically, as used herein and in the claims, the singular forms “a” and “an” include the plural reference unless the context clearly indicates otherwise. Also, as used herein and in the claims, the terms “at least one” and “one or more” have the same meaning and include one, two, three, or more.

Terms such as “at least one embodiment”, “one embodiment”, “multiple embodiments”, “different embodiments”, “some embodiments”, “present embodiment”, and the like may indicate that an embodiment of the present disclosure so described may include a particular feature, structure, or characteristic, but not every possible embodiment of the present disclosure must include a particular feature, structure, or characteristic. Furthermore, repeated use of the phrases “in one embodiment”, “in the embodiment”, and so on does not necessarily refer to the same embodiment, although they may be identical. Furthermore, the use of phrases such as “embodiments” in connection with “the present disclosure” does not imply that all embodiments of the present disclosure necessarily include a particular feature, structure, or characteristic, and should be understood as “at least some embodiments of the present disclosure” include the particular feature, structure, or characteristic described.

Additionally, for the purposes of explanation and non-limitation, specific details such as functional entities, techniques, protocols, standards, and the like are set forth for providing an understanding of the described technology. In other examples, detailed disclosure of well-known methods, technologies, systems, architectures, and the like are omitted so as not to obscure the disclosure with unnecessary details.

The terms “first”, “second”, and “third” in the description of the present disclosure and the above-mentioned drawings are used to distinguish different objects, rather than to describe a specific order.

Furthermore, the term “comprising” and any variations thereof are intended to cover non-exclusive inclusions and may refer to “including but not necessarily limited to”, which specifically indicates open-ended inclusion or membership in the so-described combination, group, series, and the equivalent. For example, a process, method, system, product, or device that includes a series of steps or modules is not limited to the listed steps or modules, but optionally also includes steps or modules that are not listed, or optionally also includes other steps or modules that are inherent to those processes, methods, products, or devices.

The present disclosure proposes a computer-implemented method for Voice Activity Detection (VAD) that could adapt to input utterances under different scenarios to accurately determine whether the input utterance corresponds to a target object or whether the utterance from the target object is present within the input utterance. It should be noted that in various implementations of the present disclosure, the examples of different scenarios for input utterances will be illustratively described using different numbers of simultaneous speakers. However, the disclosure is not limited to these examples. A person skilled in the art could apply the computer-implemented method proposed by the present disclosure to the desired scenarios based on the technical concepts introduced in these implementations.

The implementations of the present disclosure are described below with reference to the accompanying drawings.

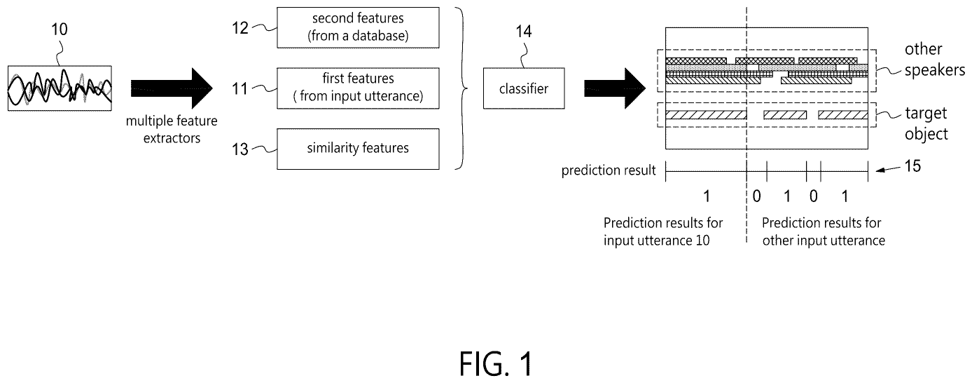

FIG. 1 is a schematic diagram illustrating a voice activity detection method according to an example implementation of the present disclosure. The voice activity detection method, for example, is executed by a voice activity detection system including a memory and a processor. Details regarding the voice activity detection system will be described in subsequent paragraphs.

Referring to FIG. 1, the input utterance 10, for example, includes overlapping utterances from multiple speakers. The voice activity detection method proposed in the implementations of the present disclosure is used to determine whether the target object is included among these speakers. In some implementations, the input utterance 10 may be derived by segmenting a longer utterance.

Specifically, the input utterance 10 may be processed by a plurality of feature extractors (e.g., five), each of the plurality of feature extractors extracts at least one of the plurality of first features 11. In some implementations, each of the plurality of feature extractors are trained using one of the plurality of training sets corresponding to different scenarios (e.g., the number of simultaneous speakers). As a result, each scenario (e.g., the number of simultaneous speakers) corresponds to one of the first features 11.

Additionally, a plurality of second features 12 corresponding to the target object and the plurality of scenarios are retrieved from a database, where each scenario may correspond to at least one of the plurality of second feature 12. Specifically, in the same scenario, the greater the similarity between a first feature 11 and a second feature 12, the more likely the input utterance 10 contains utterance from the target object. Accordingly, the voice activity detection method calculates a plurality of similarity features 13 between the first features 11 and the second features 12 in each scenario, based on the plurality of first features 11 and the plurality of second features 12.

Based on the similarity features 13, a prediction result 15 indicating whether the input utterance 10 corresponds to the target object could be obtained by a classifier 14. Specifically, the input utterance 10 corresponds to the target object, for example, the input utterance 10 includes an utterance from the target object.

In some implementations, the input utterance 10 includes utterance from the target object, so the prediction result, for example, is 1. Similarly, for other input utterances that include utterance from the target object, the prediction result is 1. Conversely, for input utterances that do not include utterance from the target object, the prediction result is 0, as shown in FIG. 1.

Accordingly, the voice activity detection (VAD) method proposed in the implementations of the present disclosure could predict or determine whether the input utterance 10 corresponds to the target object. Furthermore, by considering the plurality of different scenarios, the VAD method in the implementations of the present disclosure maintains a high level of accuracy even when the input utterance 10 is obtained under various scenarios. For instance, even if the input utterance 10 includes overlapping utterances from multiple speakers, the VAD method in the implementations of the present disclosure could still determine whether the target object is among the plurality of speakers.

The following paragraphs will provide more detailed explanations of the VAD method of the present disclosure through multiple implementations.

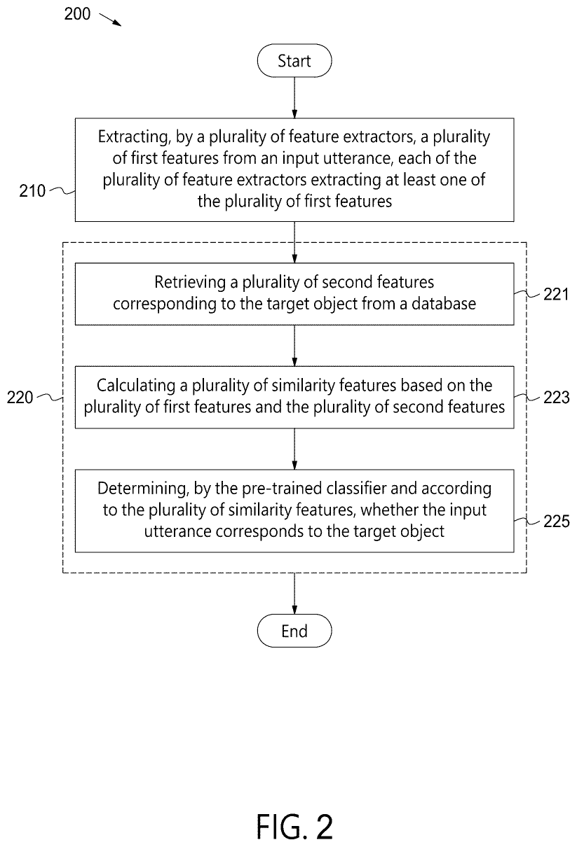

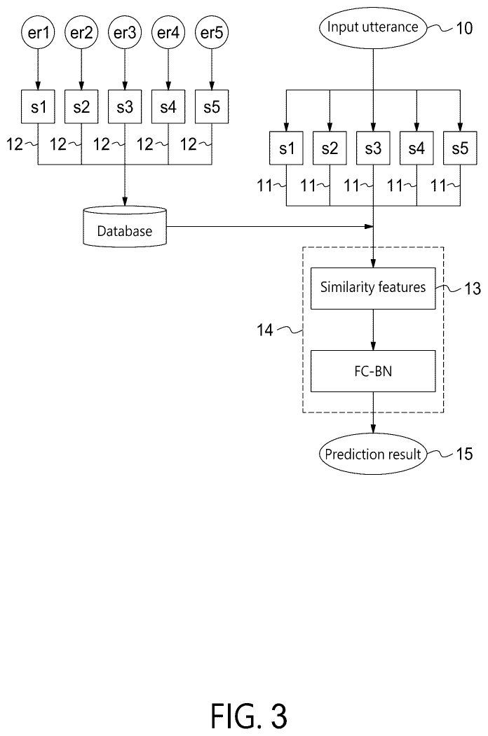

FIG. 2 is a flowchart illustrating a voice activity detection method according to an example implementation of the present disclosure, and FIG. 3 is a schematic diagram illustrating a voice activity detection method according to an example implementation of the present disclosure. In FIG. 2, the VAD method is presented, for example, as flow 200. Furthermore, as described in previous paragraphs, the VAD method is implemented, for example, by a VAD system including a memory and a processor. Accordingly, one or more elements in FIG. 3 may be implemented by executing one or more instructions stored in the memory using the processor.

Referring to FIG. 2, in operation 210, the voice activity detection (VAD) method extracts, by a plurality of feature extractors, a plurality of first features from an input utterance, each of the plurality of feature extractors extracting at least one of the plurality of first features. In operation 220, the VAD method determines, by a pre-trained classifier and according to the plurality of first features, whether the input utterance corresponds to a target object.

Referring to FIG. 3, each of the plurality of feature extractors s1-s5 extract at least one of the plurality of first features 11 from the input utterance 10. These feature extractors s1-s5, for example, are trained using the plurality of training sets er1-er5 with each set corresponding to different scenarios (e.g., the number of simultaneous speakers). Therefore, each scenario (e.g., the number of simultaneous speakers) corresponds to one of the first features 11.

For example, the first training set er1, which includes a plurality of voices with one speaker, could be used to train the first feature extractor s1. Therefore, the first feature extractor s1 corresponds to the scenario with one speaker. The second training set er2, which includes a plurality of overlapping utterances with two simultaneous speakers, could be used to train the second feature extractor s2. As a result, the second feature extractor s2 corresponds to the scenario with two simultaneous speakers. The third training set er3, which includes a plurality of overlapping utterances with three simultaneous speakers, could be used to train the third feature extractor s3, making the third feature extractor s3 correspond to the scenario with three simultaneous speakers. The fourth training set er4, which includes a plurality of overlapping utterances with four simultaneous speakers, could be used to train the fourth feature extractor s4, thus corresponding to the scenario with four simultaneous speakers. Similarly, the fifth training set er5, which includes a plurality of overlapping utterances with five simultaneous speakers, could be used to train the fifth feature extractor s5, making the fifth feature extractor s5 corresponds to the scenario with five simultaneous speakers, and so on.

In some implementations, multiple users, for example, may register with the voice activity detection system respectively, allowing the activity detection system to obtain multiple utterances from each individual user. Based on these utterances of the plurality of users, the aforementioned training sets er1-er5 could be created through synthesis or other methods. The present disclosure does not limit the specific method used to create the training sets er1-er5. However, it should be noted that, to determine whether the input utterance 10 corresponds to the target subject, each of the training sets er1-er5 will correspond to the target subject. That is, each training set er1-er5 will include multiple utterances from the target subject.

In some implementations, the size of the training sets is positively correlated with the corresponding number of simultaneous speakers. The frequency of occurrences of the same user in the training sets is also positively correlated with the corresponding number of simultaneous speakers. Advantageously, the design allows more complex overlapping utterances to have a greater amount of training data, thus achieving improved training performance.

For example, the first training set er1 includes 50 users, each user contributing 100 utterances, resulting in a total of 50×100 utterances, and each user appears 100 times in the first training set er1. The second training set er2 includes 100 user combinations, each user combination contributing 100 utterances, resulting in a total of 100×100 utterances. Each user appears 4 times in the 100 user combinations, and therefore appears 400 times in the second training set er2. The third training set er3 includes 150 user combinations, each user combination contributing 100 utterances, resulting in a total of 150×100 utterances. Each user appears 9 times in the 150 user combinations, and therefore appears 900 times in the third training set er3. The fourth training set er4 includes 200 user combinations, each user combination contributing 100 utterances, resulting in a total of 200×100 utterances. Each user appears 16 times in the 200 user combinations, and therefore appears 1600 times in the fourth training set er4. The fifth training set er5 includes 250 user combinations, each user combination contributing 100 utterances, resulting in a total of 250×100 utterances. Each user appears 25 times in the 250 user combinations, and therefore appears 2500 times in the fifth training set er5.

In some implementations, based on the feature extractors s1-s5 which have been trained using the aforementioned training sets, a plurality of embedding vectors corresponding to each of the feature extractors s1-s5 or each scenario could be obtained. These embedding vectors are recorded in a database respectively.

In some implementations, the embedding vectors may represent a representative feature of a specific user combinations. Specifically, for each user combination in each of the training sets er1-er5, 100 utterances are input into the corresponding feature extractor to obtain 100 features. Based on these 100 features (e.g., by averaging), a representative feature (or embedding vector) is generated.

For example, for each user in the first training set er1, their 100 utterances are input into the first feature extractor s1 to obtain 100 features. The average of these 100 features is then used as the representative feature (or embedding vector). Therefore, the first feature extractor s1, or the scenario where the number of simultaneous speakers is one, may be correspond to, for example, 50 embedding vectors.

For example, for each user combination in the second training set er2, their 100 utterances are input into the second feature extractor s2 to generate 100 features. The average of these 100 features is then used as the representative feature (or embedding vector). Therefore, the second feature extractor s2, or scenarios where the number of simultaneous speakers is two, may be correspond to, for example, 100 embedding vectors.

For example, for each user combination in the third training set er3, their 100 utterances are input into the third feature extractor s3 to generate 100 features. The average of these 100 features is then used as the representative feature (or embedding vector). Therefore, the third feature extractor s3, or scenarios where the number of simultaneous speakers is three, may be correspond to, for example, 150 embedding vectors.

For example, for each user in the fourth training set er4, their 100 utterances are input into the fourth feature extractor s4 to generate 100 features. The average of these 100 features is then used as the representative feature (or embedding vector). Therefore, the fourth feature extractor s4, or scenarios where the number of simultaneous speakers is four, may be correspond to, for example, 200 embedding vectors.

For example, for each user in the fifth training set er5, their 100 utterances are input into the fifth feature extractor s5 to generate 100 features. The average of these 100 features is then used as the representative feature (or embedding vector). Therefore, the fifth feature extractor s5, or scenarios where the number of simultaneous speakers is five, may be correspond to, for example, 250 embedding vectors.

Referring to FIG. 2, in some implementations, operation 220 further includes operations 221, 223, and 225.

In operation 221, a voice activity detection method retrieves a plurality of second features corresponding to the target object from the database.

Referring to FIG. 3, the plurality of embedding vectors corresponding to the target object in the database are retrieved as the plurality of second features 12. Specifically, each embedding vector corresponds to a user combination, and when a specific user combination includes the target object, the corresponding embedding vector is retrieved as the second feature 12. Therefore, each scenario (or each feature extractor s1-s5) will correspond to, for example, at least one second feature 12.

In some implementations, the number of second features 12 in each scenario is positively correlated with the number of simultaneous speakers in that scenario. In other words, the more simultaneous speakers in a given scenario, the greater the number of second features 12. Advantageously, this design allows more reference features for more complex overlapping utterances, which helps achieve better prediction accuracy.

For example, a scenario with one speaker includes one second feature 12; a scenario with two simultaneous speakers includes four second features 12; a scenario with three simultaneous speakers includes nine second features 12; a scenario with four simultaneous speakers includes sixteen second features 12; and a scenario with five simultaneous speakers includes twenty-five second features 12.

Referring to FIG. 2, in operation 223, the voice activity detection method calculates a plurality of similarity features based on the plurality of first features and the plurality of second features.

Referring to FIG. 3, the plurality of similarity features 13, for example, includes the average similarity between the first feature 11 and at least one second feature 12 in each scenario. For example, the plurality of similarity features 13 includes: in a scenario with one speaker, the similarity between the first feature 11 and one second feature 12; in a scenario with two simultaneous speakers, the average similarity between the first feature 11 and four second features 12; in a scenario with three simultaneous speakers, the average similarity between the first feature 11 and nine second features 12; in a scenario with four simultaneous speakers, the average similarity between the first feature 11 and sixteen second features 12; and in a scenario with five simultaneous speakers, the average similarity between the first feature 11 and twenty-five second features 12.

In some implementations, the similarity, for example, is cosine similarity, but the present disclosure is not limited to the specific implementation type of the similarity.

In some implementations, the multiple similarity features 13 also include at least one of the similarity mean and the similarity variance.

Referring to FIG. 2, in operation S225, the voice activity detection method determines, by the pre-trained classifier and according to the plurality of similarity features, whether the input utterance corresponds to the target object.

Referring to FIG. 3, the input layer of classifier 14, for example, includes the plurality of similarity features 13, while the output layer, for example, includes the prediction result 15 that indicates whether the input speech 10 corresponds to the target object.

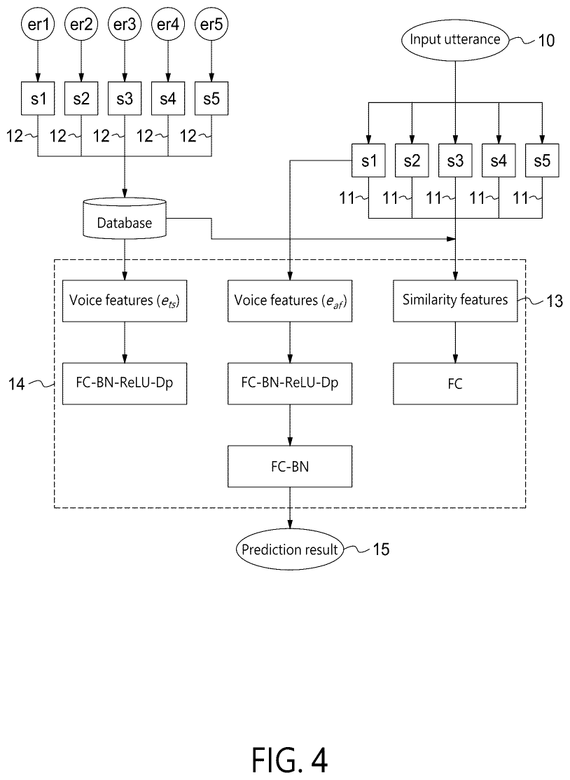

FIG. 4 is a schematic diagram illustrating a voice activity detection method according to an example implementation of the present disclosure.

Referring to FIG. 4, in some implementations, to enhance accuracy, the input layer of the classifier 14 may include other information in addition to the multiple similarity features 13.

In some implementations, the above-mentioned other information includes a plurality of voice features eₜₛ corresponding to multiple users. For example, the plurality of voice features eₜₛ corresponding to a plurality of users includes 50 embedding vectors associated with the first feature extractor s1 in the database, but is not limited thereto.

In some implementations, the above-mentioned other information includes specific voice features e_{af} of the input utterance 10. For example, the specific voice feature e_{af} includes one of the first features 11, such as the first feature 11 obtained by the first feature extractor s1, but is not limited to this.

It is worth noting that, in the classifiers 14 of FIGS. 3 and 4, in addition to the similarity feature 13 (e.g., input layer), other layer architectures included in the classifier 14 are exemplarily represented as FC, FC-BN, and FC-BN-ReLU-Dp. However, the present disclosure is not limited to the specific architecture of classifier 14. Furthermore, the specific training methods for classifier 14 are also outside the scope of the present disclosure, and those skilled in the art could implement training based on actual requirements. For example, classifier 14 may be trained using an existing voice database as a training set or obtained by fine-tuning another pre-trained classifier.

In some implementations, the output of the classifier 14 may be a binary output indicating whether the input utterance corresponds to the target subject. Accordingly, the voice activity detection method and system described in the foregoing implementations could effectively determine whether the input utterance corresponds to the target subject.

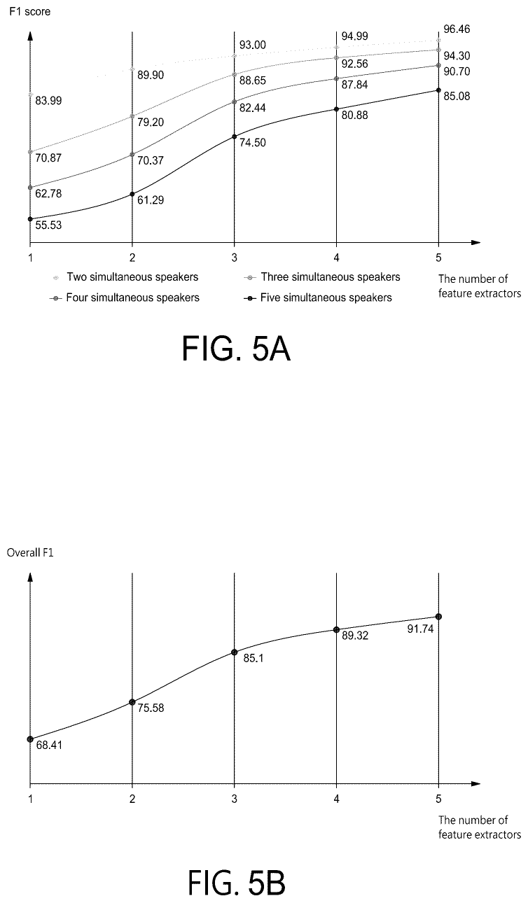

FIGS. 5A and 5B are line graphs illustrating an impact of a number of feature extractors on accuracy according to an example implementation of the present disclosure. FIGS. 5A and 5B show the accuracy trends obtained by conducting experiments based on the architecture of the voice activity detection system in the implementation of FIG. 4 (with different numbers of feature extractors). The horizontal axis represents the number of feature extractors in the voice activity detection system.

In FIG. 5A, the vertical axis represents the F1 score. As shown in FIG. 5A, regardless of whether there are 2, 3, 4, or 5 simultaneous speakers, in the case of 1 to 5 feature extractors, the accuracy of the voice activity detection system increases as the number of feature extractors increases. In FIG. 5B, the vertical axis represents the overall F1 score, which is the average of the F1 scores corresponding to 2, 3, 4, or 5 simultaneous speakers.

It is worth mentioning that although the trend shows that the more feature extractors there are, the higher the accuracy of the voice activity detection system, FIGS. 5A and 5B show that as the number of feature extractors increases, the improvement in the F1 score becomes less efficient. Therefore, based on the experimental results in FIGS. 5A and 5B, five feature extractors may be the most appropriate choice.

Table 1 shows the accuracy trend obtained from experiments based on the voice activity detection system in the implementation of FIG. 4, where five feature extractors were used to test scenarios with 2 to 8 simultaneous speakers.

TABLE 1

| | Simultaneous speakers | | | | | | |
|---|---|---|---|---|---|---|---|
| | 2 | 3 | 4 | 5 | 6 | 7 | 8 |
| F1 score | 94.28 | 94.11 | 91.24 | 85.74 | 81.70 | 77.44 | 71.27 |
| overall F1 | 75.58 | 85.10 | 89.32 | 91.74 | 89.61 | 87.71 | 85.57 |

From Table 1, it could be seen that while 5 feature extractors were trained using training sets corresponding to 2, 3, 4, and 5 simultaneous speakers, the system still performs well when the number of simultaneous speakers increases to 8.

It is worth noting that if more than 5 feature extractors are used, creating the training sets will become more difficult, and both the hardware and time costs for training will increase significantly. Tests show that in the architecture of the voice activity detection system in the implementation of FIG. 4, if the number of feature extractors is increased to 6 (for example, by adding a sixth feature extractor trained using a training set corresponding to 6 simultaneous speakers), the overall F1 score for overlapping utterances with 5 simultaneous speakers drops to 91.57%, which is even lower than the configuration with 5 feature extractors.

Based on the multiple experiments above, one may conclude that 5 feature extractors are the optimal choice for the voice activity detection system in the implementation of the present disclosure.

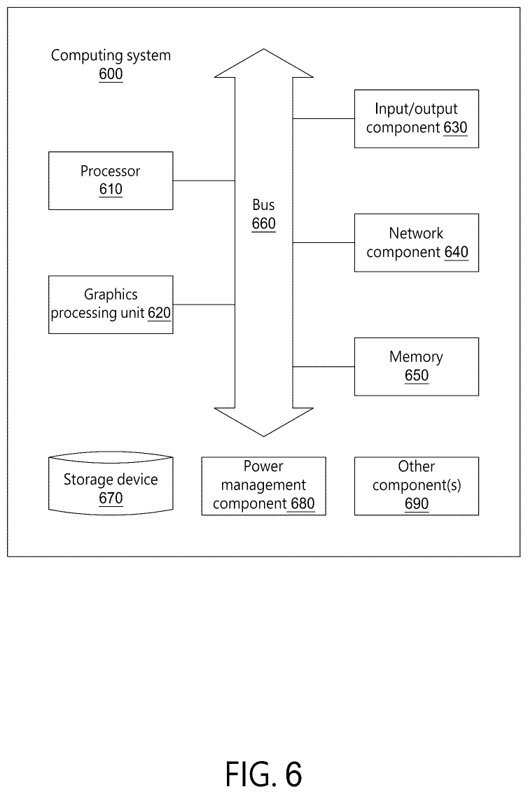

FIG. 6 is a block diagram illustrating a computing system according to an example implementation of the present disclosure.

Referring to FIG. 6, computer-implemented methods such as methods for voice activity detection introduced in this article, as well as other computer-implemented methods, may be implemented on a computing system 600 with various hardware components. In other words, the computing system 600 may be implemented as a voice activity detection system. In some implementations, the computing system 600 may be implemented in the form of an electronic device, which may include, but is not limited to, one or more of the following components: processor (e.g., Central Processing Unit (CPU)) 610, Graphics Processing Unit (GPU) 620, input/output components 630, network components 640, and memory 650. These components may communicate and transfer data via the system bus 660. However, the present disclosure does not limit the specific models, quantities, and configurations of these components. Those skilled in the art can adjust, select, or add/subtract components based on the specific requirements and operating environment when implementation

In some implementations, the primary computing core inside the computing system 600 is one or more processors 610. This processor 610 may be responsible for running the main computational processes and related control logic of algorithms, such as deep learning. In some implementations, the processor 610 may be configured to execute processing instructions (e.g., machine/computer-executable instructions) stored in non-volatile computer-readable media (e.g., storage device 670).

In some implementations, to enhance the computational efficiency of deep learning, the computing system 600 may also include one or more graphics processing unis 620 designed for massive parallel computations. The graphics processing unit 620 may effectively improve the system's computational capacity during deep learning training and inference.

In some implementations, the computing system 600 may include various input/output components 630 configured to receive user input and display system output. For example, the input/output components 630 may include a keyboard, mouse, touchpad, display screen, speakers, and other types of sensing devices.

In some implementations, the computing system 600 may also include network components 640 configured for network communication. For example, the network component 640 may include a network interface card for wired or wireless network connections, or communication modules for 3G, 4G, 5G, or other wireless communication technologies.

In some implementations, the computing system 600 may include one or more memory components 650, such as volatile memory components like Random Access Memory (RAM). The memory 650 may store the parameters of the deep learning model, as well as other data and programs used to run algorithms like deep learning.

Furthermore, the computing system 600 may also include one or more of the following components: storage devices 670, power management components 680, and other various hardware components 690.

In some implementations, the computing system 600 may include one or more storage devices 670, such as non-volatile memory components like Hard Disk Drive (HDD) or Solid State Drive (SSD). The storage devices 670 may be configured to store the code of deep learning software, training data, model parameters, etc. Additionally, storage devices 670 may also be configured to store intermediate results and final outputs of algorithms like deep learning. In some implementations, the storage device 670 may be implemented as a database in the voice activity detection system according to some implementations of the present disclosure.

In some implementations, the computing system 600 may include one or more power management components 680 configured to provide power to various hardware components of the computing system 600 and manage their power consumption. This power management component 680 may include batteries, power converters, and other power management devices.

In some implementations, the computing system 600 may also include other (hardware) components 690, such as cooling fans, heat dissipators, and other various control and monitoring devices. The present disclosure is not limited to the examples provided herein in this regard.

Additionally, implementations of the present disclosure may also be implemented as one or more computer program products or one or more non-transitory computer-readable medium, which include one or more instructions of a computer program. Specifically, the computer program (also referred to as a program, software, script, or code) may be presented in any form of programming language and can be deployed in any form. During the operation of the computing system 600 (e.g., electronic device), the instructions or part of them may reside entirely or at least partially inside the processor 610, allowing the processor 610 to execute the methods introduced in the disclosure.

In summary, the voice activity detection method and system proposed in the implementations of the disclosure incorporate multiple feature extractors corresponding to various scenarios within the framework. As a result, these feature extractors enable the system to accommodate input utterance from different scenarios and accurately predict whether the input speech corresponds to a target subject. For example, in cases where the input utterance includes overlapping utterances from multiple speakers, the voice activity detection method and system proposed in the implementations of the disclosure could still effectively distinguish and identify the voice activity of a specific speaker. Furthermore, the implementations of the disclosure also provide a selection scheme for determining the optimal number of feature extractors, thus enabling the achievement of optimal performance at an appropriate cost.

Based on the above description, it is apparent that various techniques can be configured to implement the concepts described in this application without departing from their scope. Furthermore, although certain implementations have been specifically described and illustrated, those skilled in the art will recognize that variations and modifications can be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions can be made within the scope of the present disclosure.

What is claimed is:

1. A computer-implemented method for voice activity detection (VAD), the computer-implemented method comprising:
extracting, by a plurality of feature extractors, a plurality of first features from an input utterance, each of the plurality of feature extractors extracting at least one of the plurality of first features; and
determining, by a pre-trained classifier and according to the plurality of first features, whether the input utterance corresponds to a target object, wherein
each of the plurality of feature extractors is trained by one of a plurality of training sets corresponding to a plurality of different scenarios.

2. The computer-implemented method of claim 1, wherein determining, by the pre-trained classifier and according to the plurality of first features, whether the input utterance corresponds to the target object comprises:
retrieving a plurality of second features corresponding to the target object from a database;
calculating a plurality of similarity features based on the plurality of first features and the plurality of second features; and
determining, by the pre-trained classifier and according to the plurality of similarity features, whether the input utterance corresponds to the target object, wherein each of the plurality of second features correspond to one of the plurality of different scenarios.

3. The computer-implemented method of claim 2, wherein the plurality of different scenarios comprises a plurality of numbers of simultaneous speakers.

4. The computer-implemented method of claim 3, wherein a number of the plurality of second features in each of the plurality of different scenarios is positively correlated with a number of the simultaneous speakers in each of the plurality of different scenarios.

5. The computer-implemented method of claim 3, wherein each of the plurality of numbers of simultaneous speakers does not exceed five.

6. The computer-implemented method of claim 2, wherein determining, by the pre-trained classifier and according to the plurality of first features, whether the input utterance corresponds to the target object comprises:
retrieving a plurality of sound features corresponding to a plurality of users from the database; and
determining, based on the plurality of similarity features, the plurality of sound features, and one of the plurality of first features, whether the input utterance corresponds to the target object through the pre-trained classifier.

7. The computer-implemented method of claim 2, further comprising:
creating the plurality of training sets corresponding to the target object in the plurality of different scenarios;
training each of the plurality of feature extractors by one of the plurality of training sets;
obtaining, by the plurality of feature extractors which is trained, a plurality of embedding vectors corresponding to the plurality of different scenarios; and
storing the plurality of embedding vectors in the database, wherein the plurality of embedding vectors comprises the plurality of second features.

8. The computer-implemented method of claim 1, wherein the plurality of feature extractors comprises a number of five.

9. A voice activity detection system, comprising:
a memory storing the plurality of feature extractors; and
a processor coupled to the memory and configured to perform the computer-implemented method of claim 1.

10. A non-transitory computer-readable medium, comprising:
at least one instruction, wherein when the at least one instruction is executed by a processor of an electronic device, the electronic device is configured to perform the computer-implemented method of claim 1.
